(19) United States
(12) Patent Application Publication
(10) Pub. No.: US 2006/0219787 A1
(43) Pub. Date: Oct. 5, 2006

(54) Sheet body, information writing method, information reading method, and information reading apparatus

(75) Inventors: Yasunori Koda, Ashigarakami-gun (JP); Shoji Yamaguchi, Ashigarakami-gun (JP); Kunihiro Takahashi, Ashigarakami-gun (JP); Mario Fuse, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/213,966

(22) Filed: Aug. 30, 2005

(30) Foreign Application Priority Data
Mar. 18, 2005 (JP) 2005-79954

(51) Int. Cl. B32B 15/00; G06K 7/08; G06K 19/06

(52) U.S. Cl. 235/449; 428/692.1; 235/493

(57) ABSTRACT

A sheet body including plural magnetic wires arranged and embedded along a longitudinal direction of the sheet body at a predetermined interval, wherein each of the magnetic wires is formed by two kinds of magnetic bodies with different coercive forces into a linear shape of a predetermined length, and the magnetic wire column with stronger coercive force is magnetized, thereby preventing the magnetic wire column with weaker coercive force from generating a response signal to an alternating magnetic field.

### CROSS-REFERENCE TO RELATED APPLICATION

This application claims priority under 35 USC 119 from Japanese Patent Application No. 2005-79954, the disclosure of which is incorporated by reference herein.

### BACKGROUND OF THE INVENTION

1. Field of the Invention

The present invention relates to a sheet body that enables a predetermined amount of information to be written using two kinds of magnetic materials with different coercive forces, an information writing method, an information reading method, and an information reading apparatus.

2. Description of the Related Art

A method of reading information recorded on a sheet in a non-contact manner using recording medium such as paper as data carriers adopts barcodes. With the barcodes, however, codes recorded on sheets are optically read, and thus, when the surfaces of the sheets are blotted, accurate reading is difficult.

On the other hand, a method of enabling reading information formed on recording medium such as sheets in a non-contact manner utilizes the Barkhausen effect. In this method, when an alternating magnetic field is applied to a magnetic material with weak coercive force, a pulse-shaped response signal is generated when magnetic reversal occurs, so that presence/non-presence of the response signal can be used as information.

When such a Barkhausen effect is used, magnetic materials with different coercive forces are used, whether or not the magnetic material with weak coercive force generates the response signal with respect to the alternating magnetic field is determined based on whether or not the magnetic field with strong coercive force is magnetized. For this reason, the information can be rewritten.

When packets or the like are sent, clients put addresses on predetermined sheets by handwriting, but because of the wide spread usage of personal computers and/or printers, the addresses of the parcels are occasionally printed on the sheets using the printers.

Further, codes representing, for example, addresses, which are used by traders, are recorded on the sheets, and the codes on the sheets attached on packets are ready to be used, for example, for sorting packets according to sections and traceability.

On the other hand, in order to automate distribution of packets or the like, it is preferable that necessary information is coded to be recorded by using barcodes or RFID, so as to be capable of being read in a non-contact manner. Since, however, it is necessary to finally make a visual check, it is necessary to record predetermined information as characters together with the information readable in non-contact manner. As a result, when barcodes or RFID are used, an area where characters are recorded is limited.

Some of packets to be distributed require storage under high humidity and low temperature like fresh food, frozen and chilled commodities, and when barcodes and RFID are used for such packets, reading of information often becomes difficult.

Further, postcards and sealed letters are sorted by reading postal codes using an OCR function, and thus writing postal codes as well as addresses is required. The entered postal codes, however, are not always read accurately.

Such defective reading of information causes declining of shipment throughput when a lot of packets are sequentially sorted, and thus this is a critical issue for speeding up the distribution.

On the contrary, information recorded using a magnetic material can be read accurately even under the influence of severe temperature and humidity. However, for example, 7 digits in the decimal system and 24 digits in binary code are necessary only for postal codes.

In the conventional proposals, only basically 1 bit (presence/non-presence of information) of information is treated basically, and thus a large amount of information cannot be written nor read.

### SUMMARY OF THE INVENTION

The present invention has been made in view of the above circumstances and provides a sheet body that enables a large amount of information to be written by using magnetic materials with different coercive forces, a method of writing information into the sheet body, an information reading method of reading information written into the sheet body, and an information reading apparatus that enables sorting based on the read information.

A sheet body of the invention for achieving the above object includes plural of magnetic wires arranged and embedded along a longitudinal direction of the sheet body at a predetermined interval, wherein each of the magnetic wires is formed by two kinds of magnetic bodies with different coercive forces into a linear shape of a predetermined length, and the magnetic wire column with stronger coercive force is magnetized, thereby preventing the magnetic wire column with weaker coercive force from generating a response signal to an alternating magnetic field.

According to the invention, a wire column where a plural of magnetic wires are arranged linearly is formed, information each bit of which represents whether or not the magnetic wires generate the response signal to the alternating magnetic field is held in the wire column.

As a result, a large amount of information can be held according to the number of the magnetic wires.

The information reading method of the invention is characterized by wire columns where magnetic wires formed by two kinds of different magnetic bodies with different coercive forces into a linear shape of a predetermined length are arranged at a predetermined interval are embedded, and into which the information is written by selectively magnetizing the magnetic wire column with stronger coercive force of the two magnetic bodies, the information reading method including: applying an alternating magnetic field to the magnetic wires, relatively moving a detecting section which can detect a response signal generated from the magnetic wire column with weaker coercive force with respect to the alternating magnetic field along a column direction of the wire columns, and simultaneously reading presence and non-presence on the response signal according to positions of the magnetic wires.

As a result, quick information reading is enabled.

Moreover, the information reading apparatus of the invention is characterized in that the information reading apparatus sorts an object to which a sheet body, into which wire columns where magnetic wires formed by two kinds of magnetic bodies with different coercive forces into a linear shape of a predetermined length are arranged at a predetermined interval are embedded and information is written by selectively magnetizing the magnetic wire column with stronger coercive force of the two magnetic bodies, is attached based on information written into the sheet body, the information reading apparatus includes: a transporting section that transports the object at a predetermined transporting speed; an exciting coil that is provided so as to be opposed to the wire columns of the sheet body attached to the object to be transported by the transporting section and applies an alternating magnetic field; a detecting section that detects a response signal when the magnetic wire column with weaker coercive force of the two magnetic bodies generates the response signal according to the alternating magnetic field applied by the exciting coil; and a determining section that determines information written into the sheet body according to presence and non-presence of the response signals from the magnetic wires of the wire columns.

As explained above, according to the invention, the wire column where the magnetic wires are arranged at the predetermined interval is provided so that a large amount of information can be written into the sheet body. Further, in the invention, when the sorting or the like is carried out based on the information written into the sheet body, an excellent effect such that the smooth and efficient work is enabled can be obtained.

### BRIEF DESCRIPTION OF THE DRAWINGS

Embodiments of the present invention will be described in detail based on the following figures, wherein:

FIG. 1 is a schematic diagram illustrating a delivery system according to an embodiment.

FIG. 2 is a schematic diagram of a sheet, which is subject to a printing process.

FIG. 3 is a schematic diagram illustrating a basic configuration of a wire column to be embedded in the sheet.

FIG. 4 is a schematic configurational diagram of a main section of a PC and a printer.

FIG. 5A is a schematic diagram illustrating a wire column which is provided with a head pit.

FIG. 5B is a schematic diagram illustrating one example where information is written into the wire column of FIG. 5A.

FIG. 6 is a schematic configurational diagram of a main section of the sorting step.

FIG. 7 is a schematic configurational diagram illustrating one example of a reading apparatus.

FIG. 8 is a schematic perspective view illustrating an arrangement of an exciting coil.

FIG. 9 is a flowchart illustrating an outline of the printing process by means of a printer.

FIG. 10A is a schematic diagram illustrating another example of the head pit to be formed on the sheet.

FIGS. 10B and 10C are schematic diagrams illustrating examples where information is written into the wire column of FIG. 10A.

FIGS. 11A and 11B are schematic diagrams illustrating another examples of the information writing method.

FIGS. 12A and 12B are schematic diagram illustrating another examples of the arrangement of the exciting coil.

FIGS. 13A and 13B are schematic diagrams illustrating another examples of the exciting coil applicable to the invention.

FIG. 14 is a schematic diagram illustrating an arrangement example of the exciting coil that enables reading of information from a sheet on a front or rear side of a packet along a transporting direction.

### DETAILED DESCRIPTION OF THE INVENTION

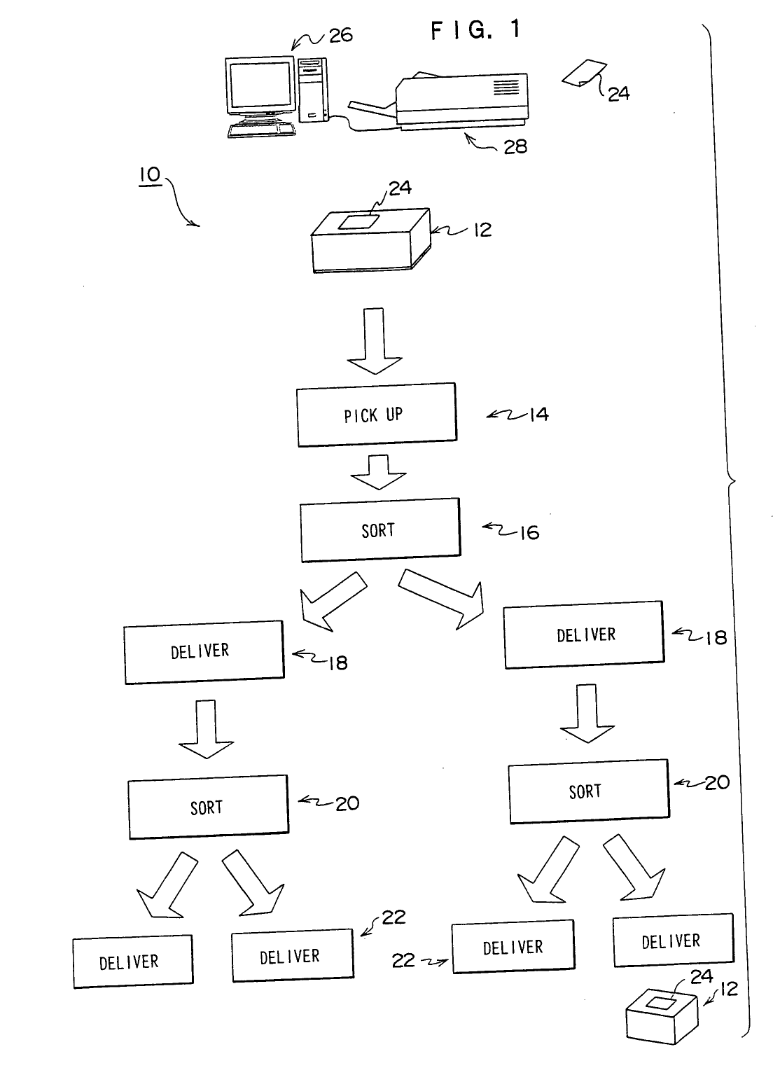

An embodiment of the present invention is explained below with reference to the drawings. FIG. 1 illustrates a schematic configuration of a delivery system 10 applied to the embodiment. The delivery system 10 delivers a packet 12 kept from a client to a specified address.

The delivery system 10 is composed of a pickup step 14 of picking up packets kept from clients into pickup centers, a sorting step 16 of sorting the picked-up packet 12 according to, for examples, delivery areas, a delivery step 18 of delivering the packet 12 sorted at the sorting step to delivery centers in the corresponding delivery areas, a sorting step 20 of sorting the delivered packet 12 according to sections of addresses, and a delivery step 22 of delivering the packet 12 sorted according to the sections to specified addresses.

Since a flow of the basic process in the delivery system 10 applied to this embodiment can adopt a conventional well-known configuration, detailed explanation is omitted here. Further, the packet 12 may be packaged by cardboard, or may be packaged into bags for packing, or may be sealed matters. Further, the packet 12 may be fresh food, chilled or frozen food, but box bodies such as cardboard are explained here as an example.

When a client asks for the packet 12 to be delivered, the client enters necessary information such as an address into a predetermined delivery request sheet (hereinafter, a sheet 24). The client attaches the sheet 24 filled with the necessary information as a delivery ticket to a predetermined position of the packet 12 so as to ask for the delivery.

As a result, the packet 12 where the sheet 24 is attached to the predetermined position is picked up at the sorting step 16.

On the other hand, in the delivery system 10 applied to this embodiment, the description of the address on the sheet 24 is carried out by using, for example, a personal computer (hereinafter, PC 26) and a printer 28. Predetermined software for printing address or the like is installed in the PC 26, and the client inputs necessary information such as address using the software, so that client's predetermined information such as the address (hereinafter, generally referred to as an address or the like) is printed.

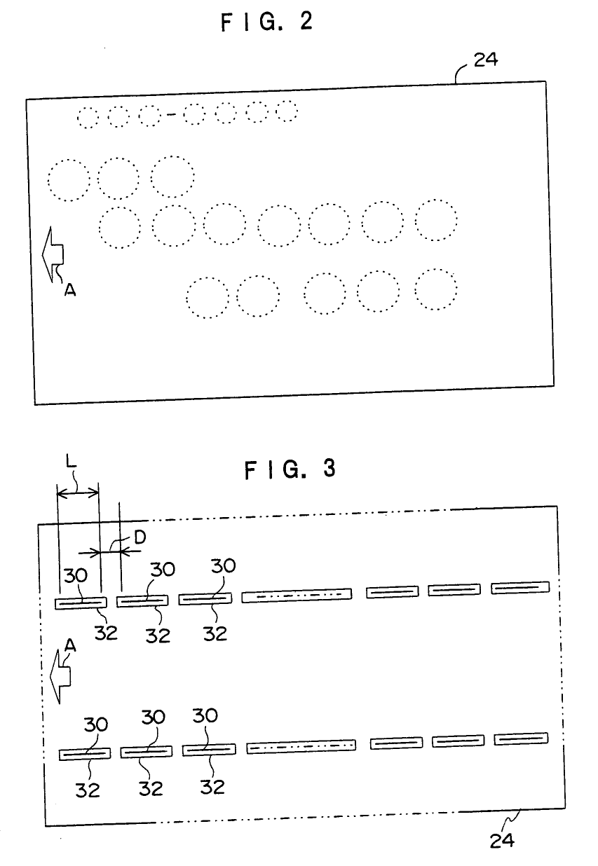

FIG. 2 is an outline of the sheet 24 on which printing and outputting are carried out by the printer 28. Items to be printed on the sheet 24 may be any one of necessary items for the delivery, and an arbitrary form can be used.

An arrow A which enables visual inspection of a printing direction is formed on the sheet 24, and for example, when the printer 28 is loaded with the sheet 24 where the direction shown by the arrow A indicates a transporting direction, the address or the like is printed in an appropriate direction and a position.

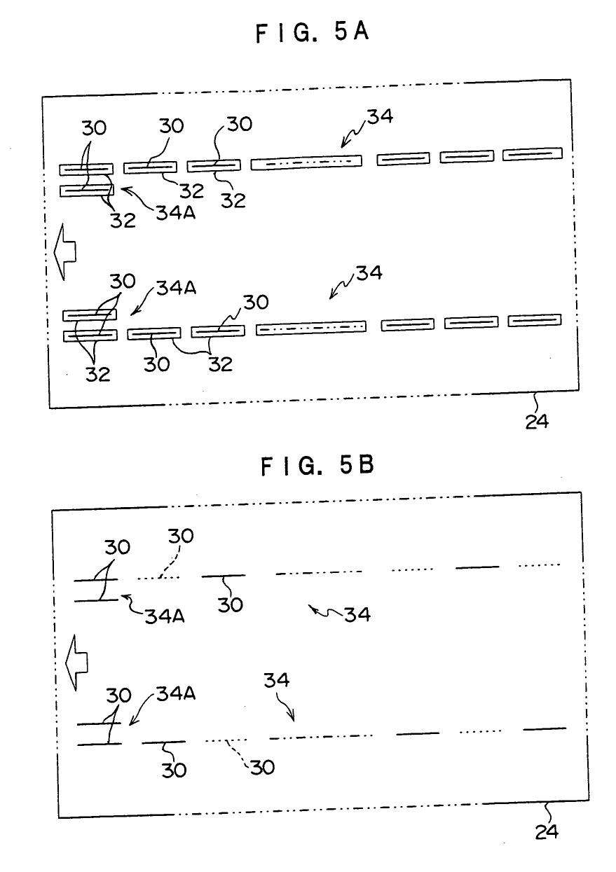

Meanwhile, as shown in FIG. 3, magnetic wire rods 30 to be a first magnetic material and magnetic bands 32 to be a second magnetic material are embedded in predetermined positions of the sheet 24 to be applied to the delivery system 10 according to this embodiment. Instead of the form shown in FIG. 3, a form shown in FIG. 5 is occasionally applied.

As shown in FIG. 3, the magnetic wire rods 30 are formed into a thin line shape so as to have a predetermined length L, and are arranged linearly at a predetermined interval D, for example, along the direction of the arrow A to be the transporting direction of the sheet 24. The magnetic bands 32 are provided so as to cover the magnetic wire rods 30 correspondingly to each of the magnetic wire rods 30.

As the magnetic wire rods 30, an arbitrary magnetic material such as amorphous silicon made of Co—Fe—Ni—B—Si whose coercive force is comparatively weak and hysteresis loop having an approximately rectangular shape can be used. Further, the magnetic wire rods 30 have, for example, an outer diameter of about 30 μm, and an approximately same length L of at least 7 mm or more, preferably 10 mm or more.

The magnetic bands 32 are formed by using a magnetic material whose coercive force is stronger than that of the magnetic wire rods 30. That is to say, the magnetic wire rods 30 and the magnetic bands 32 are formed by using the magnetic materials with different coercive forces.

Further, a predetermined magnetic material is made to be fine particles, for example, and the magnetic bands 32 can be formed by covering the magnetic wire rods 30 as the linear magnetic materials with the granular magnetic material so as to cover the area of the magnetic wire rods 30.

In the case where the sheets 24 are formed by paper, the magnetic wire rods 30 and the magnetic bands 32 are incorporated so as to be capable of being embedded in the sheet 24. At this time, when the outer diameter of the magnetic wire rods 30 is set to be about 30 μm, even if a thickness of the sheet 24 is about 80 μm, appearance of uneven portions is absorbed on the surface of the sheet 24, so that the printing process by means of the printer 28 can be executed.

The magnetic wire rods 30 and the magnetic bands 32 can be embedded into sheet bodies of paper or resin, films or metal foil of aluminum or the like. At this time, two sheet bodies are laminated, and the magnetic wire rods 30 and the magnetic bands 32 are held between the two sheet bodies so as to be embedded.

Since the magnetic wire rods 30 have the weak coercive force and the hysteresis loop of the approximately rectangular shape, when an alternating magnetic field is applied thereto, a pulse-shaped response signal is generated at a magnetic reversal point. When this response signal is detected, the magnetic wire rods 30 can be detected.

On the contrary, the magnetic bands 32 with strong coercive force are magnetized by giving a strong magnetic field thereto, and applies a bias magnetic field to the magnetic wire rods 30. Even if an alternating magnetic field is applied to the magnetic wire rods 30 in a state where the magnetic bands 32 are magnetized and a bias magnetic field is applied to the magnetic wire rods 30, the flux reversal does not occur on the magnetic wire rods 30.

That is to say, when the magnetic bands 32 are magnetized so as to apply the bias magnetic field to the magnetic wire rods 30 and the alternating magnetic field is applied to the magnetic wire rods 30, they shift the alternating magnetic field so as to prevent the flux reversal from occurring on the magnetic wire rods 30. As a result, when the magnetic bands 32 are in the magnetized state, the magnetic wire rods 30 are in a demagnetized state since they are not detected.

When the predetermined magnetic field is applied to the magnetic bands 32 in the magnetized state, they are changed into the demagnetized state, and when the magnetic bands 32 are demagnetized, the magnetic wire rods 30 shift to the magnetized state as they can respond to the alternating magnetic field.

In the delivery system 10, predetermined information is recorded by using the plural magnetic wire rods 30 and magnetic bands 32 embedded in the sheet 24.

That is to say, since the respective magnetic wire rods 30 can be in the two states: the magnetized sate and the demagnetized state, one magnetic wire rod 30 is used to be capable of expressing data of 1 bit of “0” (for example, the demagnetized state) or “1” (for example, the magnetized state). Such magnetic wire rods 30 are arranged at a uniform interval, so that data where the number of bits is the same as the number of the magnetic wire rods 30, can be recorded.

Hereinafter, one set of the magnetic wire rod 30 and the magnetic band 32 to be used for expressing one datum is generally referred to as a magnetic wire 30, and information is represented by the fact whether the magnetic wire 30 is magnetized or demagnetized.

In this embodiment, in order to enable a large amount of information to be recorded in the sheet 24, the magnetic wires 30 are arranged in two columns along a transporting widthwise direction which is orthogonal to the direction of the sheet 24 (hereinafter, the wire column 34).

The two wire columns 34 are formed here, but the invention is not limited to this, the number of the wire columns 34 may be one or three or more. The number of columns and the number of the magnetic wires 30 in the wire column are set according to an amount of information to be recorded. Further, unnecessary magnetic wires 30 may be used as dummy data.

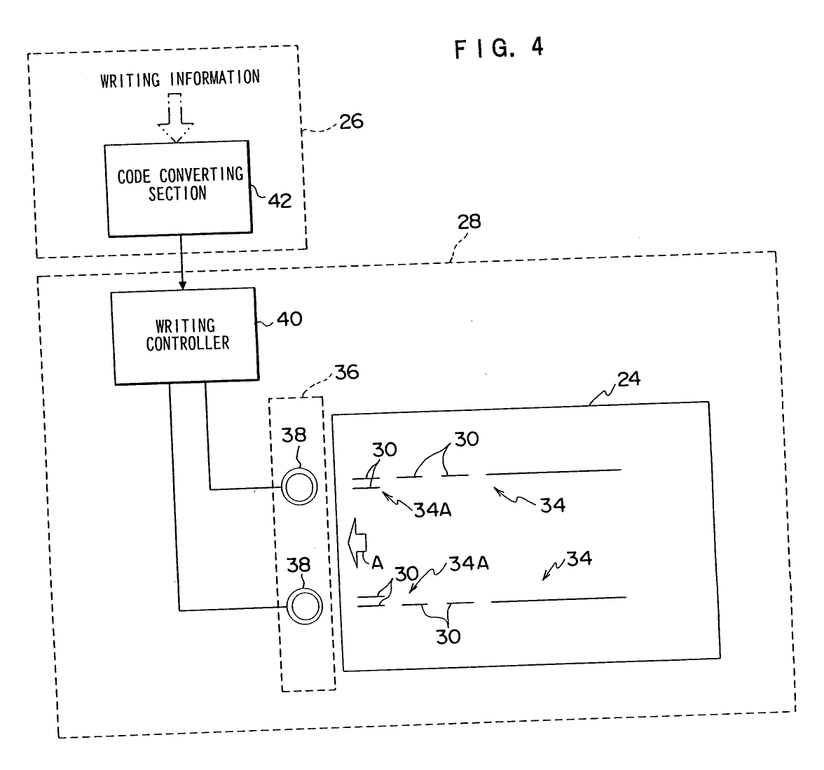

As shown in FIG. 4, the printer 28 is provided with a recording head 36. The printer 28 can adopt a well-known configuration of a laser printer using an electrophotographic process as a print engine or an ink jet printer using an ink jet system, and in FIG. 4, an image forming section (print engine) is not shown.

The sheet 24, on which the printing process has been completed, is transported at a predetermined speed v and simultaneously passes through a position opposed to the recording head 36 and then will be discharged.

The recording head 36 is provided with exciting coils 38 each of which corresponds to each of magnetic wire columns 34 on the sheet 24 respectively. Further, the printer 28 is provided with a writing controller 40 that controls an operation of the exciting coils 38.

The writing controller 40 controls an on/off operation of the exciting coils 38, and when the exciting coils 38 are operated into an ON state, a magnetic field of a predetermined strength is generated. At this time, when the magnetic wires 30 on the sheet 24 are opposed, the magnetic bands 32 are magnetized, so that the magnetic wires 30 are demagnetized.

Further, the PC 26 connected to the printer 28 is provided with a code converting section 42. The code converting section 42 converts, for example, address information input into the PC 26 into a predetermined binary code, and outputs the binary code as writing data to the writing controller 40.

The writing controller 40 operates the exciting coils 38 into the on/off state based on the writing data input from the code converting section 42 in synchronization with the transportation of the sheet 24. As a result, the magnetic wires 30 of the wire columns 34 are selectively magnetized, and the writing data are written into the sheet 24.

In general, the transporting speed of the sheet 24 in the printer 28 is 1 m/sec or less even in a high-speed printer. At this time, in order to demagnetize the magnetic wires 30 accurately, the length L of the magnetic wires (magnetic wire rod) may be 7 mm or more, and the interval D may be 5 mm or more. For example, when the length L of the magnetic wires 30 is set to 10 mm, the interval is set to 5 mm, and the length of the sheet 24 along the transporting direction is 200 mm, each wire column 34 can be formed by twelve magnetic wires 30. When the two wire columns 34 are provided, maximally 24-bit data can be written.

The data (information) are written during the same cycle as that at the time of character printing (address printing), but after the character printing is once completed, the data may be written during another cycle. Further, the information writing method is not limited to this, and the invention can adopt a method of physically cutting the magnetic wire 30 at a desired position.

Further, the sheet 24 is moved at a constant speed with respect to the recording head 36 so that the writing data are recorded, but the data may be written while the recording head 36 is being moved, or both the sheet 24 and the recording head 36 may be moved.

Meanwhile, in order to appropriately read the data, which are written into the sheet 24, it is necessary to clarify the head or the end of the data.

For this reason, in this embodiment, two magnetic wires 30 are arranged on one side of the wire column 34. That is to say, the two magnetic wires 30 are arranged on one end of the wire column 34, and the magnetic wires 30 are not to be demagnetized, but to be magnetized.

As the length L of the magnetic wires 30 is longer, the response signal of the magnetic wires 30 to the alternating magnetic field becomes stronger, but also when the number of the magnetic wires 30 is larger, the response signal becomes stronger.

As shown in FIGS. 4 and 5A, in this embodiment, the two magnetic wires 30 are provided to, for example, the head of the writing data (the direction of an arrow A), and head pits 34A are formed so that the two magnetic wires 30 are not demagnetized.

As a result, for example, the writing data are recorded as shown in FIG. 5B. At this time, the magnetic wire 30 at the head is magnetized, so that the head pit 34A and the arranging direction of the data are clarified, and the data can be read accurately. Here, the head pit 34A is formed on the respective wire columns 34, but the head pit 34A may be provided only to any one of the wire columns 34.

The sheet 24 on which the data are written in the above manner is stuck to the packet 12, and the data written into the sheet 24 are read so that the packet 12 is sorted at the sorting steps 16 and 20 in the delivery system 10. That is to say, in this embodiment, information necessary for the sorting is written into the sheet 24.

At the sorting steps 16 and 20, since the basic configuration is common, the sorting step 16 is explained as an example here.

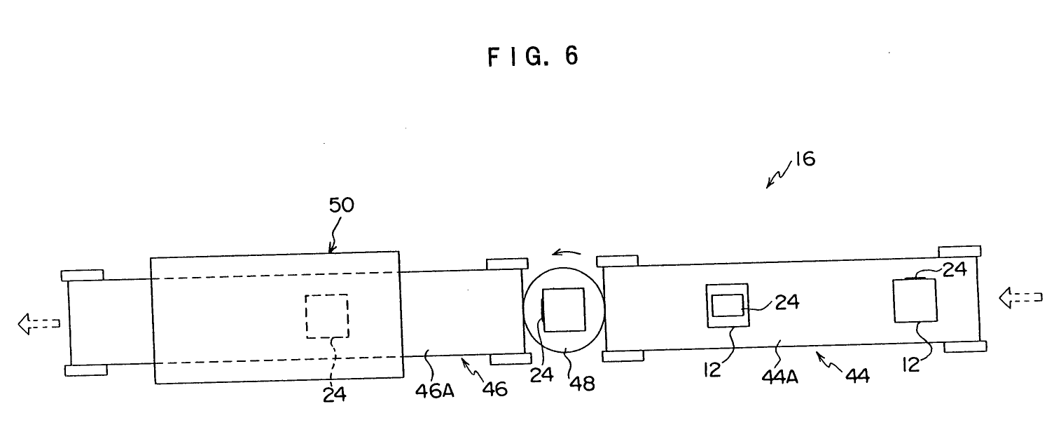

As shown in FIG. 6, at the sorting step 16, belt conveyors 44 and 46 are installed consecutively, and a turntable 48 is provided between the belt conveyors 44 and 46.

The picked-up packet 12 is placed on a conveyor belt 44A of the belt conveyor 44 at the top stream so as to be transported onto the turntable 48. The turntable 48, on which the packet 12 sent from the belt conveyor 44 is placed, can be rotated, and sends the packet 12 onto a conveyor belt 46A of the belt conveyor 46. The belt conveyors 44 and 46 are used here as transporting sections of the packet 12, but the transporting sections are not limited to them, and another configuration such as a roller conveyor can be applied.

The box-shaped packet 12 is placed on the conveyor belt 44A of the belt conveyor 44 with the sheet 24 facing in an arbitrary direction. On the turntable 48, when the sheet 24 is on a front or rear side of the transporting direction of the packet 12, the turntable 48 on which the packet 12 is placed rotates (about 90°), so that the direction of the sheet 24 of the packet 12 is changed.

As a result, the packet 12 is sent onto the conveyor belt 46A of the belt conveyor 46 with the sheet 24 facing any one of an upper surface, a lower surface and side surfaces. The packet 12 on the conveyor belt 44A occasionally tilts with respect to the transporting direction, and at this time, the packet 12 is rotated by the turntable 48 so that the tilt is corrected and may be sent onto the conveyor belt 46A.

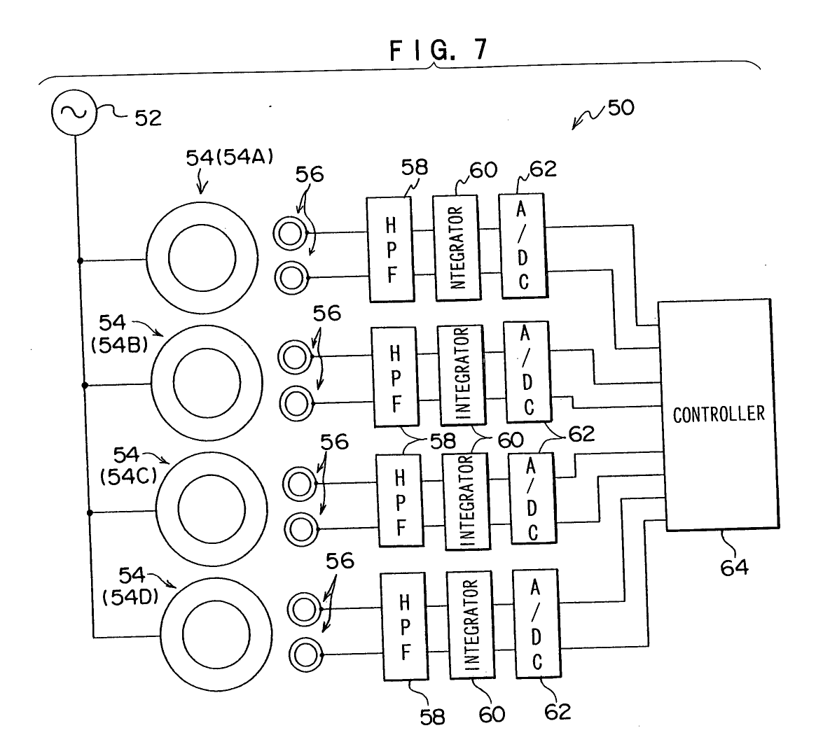

On the other hand, the belt conveyor 46 is provided with a reading apparatus 50. FIG. 7 illustrates a schematic configuration of the reading apparatus 50.

The reading apparatus 50 includes a power supply 52 that supplies an electric power for generating an alternating magnetic field, and a plurality of exciting coils 54 that generate the alternating magnetic field by means of the electric power supplied from the power supply 52. Further, a plurality of detecting coils 56 are provided to the exciting coils 54, respectively.

An electric current is induced on the detecting coils 56 according to the alternating magnetic fields generated by the exciting coils 54, and an electric current is induced on the detecting coils 56 according to the pulse-shaped response signal generated by the magnetic wires 30 according to the alternating magnetic fields.

Further, the reading apparatus 50 is provided with highpass filters (HPF) 58, integrators 60, A/D converters (AC/DC) 62 and a controller 64 that controls the operation of the reading apparatus 50 correspondingly to the detecting coils 56.

The electric currents induced by the detecting coils 56 are input into the HPFs 58, and each of the HPFs 58 removes low-frequency components from the input electric currents. The frequency of the power supply 52 is lower than the frequency of the response signal generated from the magnetic wires 30, and the HPFs 58 remove the frequency component of the power supply 52 so as to allow only the response signal component to pass.

The integrators 60 integrate the electric currents, which pass through the HPFs 58, and the A/D converters 62 converts AC/DC of the integrated electric currents. As a result, the electric currents detected by the detecting coils 56 include the response signals generated from the magnetic wires 30, so that a voltage according to the strength of the response signals is input as digital data into the controller 64.

The controller 64 reads the digital signal at timing, which synchronizes with the transporting speed of the packet 12.

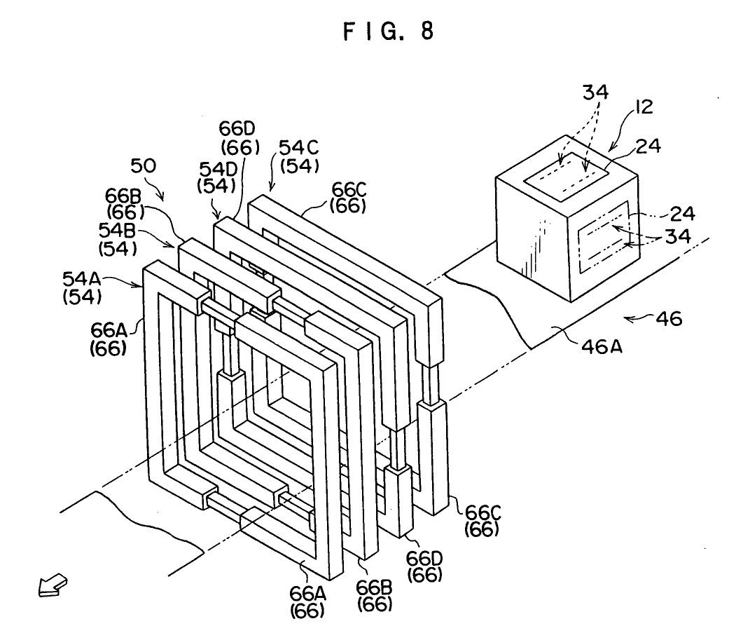

On the other hand, as shown in FIG. 8, the exciting coils 54 are formed so that their outer shape is a rectangular loop shape, and the conveyor belt 46A, on which the packet 12 is placed, moves within the loops of the exciting coils 54. When the exciting coils 54 are formed into the loop shape, the magnetic field becomes stronger in the loops than that out of the loop, so that the alternating magnetic field can be formed efficiently.

As a result, the packet 12 to be transported by the belt conveyor 46 passes through the loops of the exciting coils 54.

Further, the reading apparatus 50 is provided with the exciting coil 54 for the magnetic wire column 34 on the right side of the transporting direction of the sheet 24 stuck to the up and down surfaces of the packet 12 (hereinafter, referred to as the exciting coil 54A in order to particularly distinguish it), the exciting coil 54 for the magnetic wire column 34 on the left side of the transporting direction (hereinafter, referred to as the magnetic coil 54B in order to particularly distinguish it), the exciting coil 54 for the magnetic wire column 34 on the upper side of the sheet 24 stuck to the right and left sides of the packet 12 (hereinafter, referred to as the exciting coil 54C in order to particularly distinguish it), and the exciting coil 54 for the magnetic wire column 34 on the lower side (hereinafter, the exciting coil 54D).

In this embodiment, one wire column 34 is provided on the right and the left of the sheet 24. As one example, here, the exciting coils 54B and 54D correspond to the wire column 34 on the right side of the sheet 24 with respect to the transporting direction of the packet 12, and the exciting coils 54A and 54C correspond to the wire column 34 on the left side of the sheet 24 with respect to the transporting direction of the packet 12.

At the sorting step 16, when the packet 12 is sent to the belt conveyor 46, the surface to which the sheet 24 is stuck does not face the front surface and the rear surface of the transporting direction, and as a result, the sheet 24 stuck to the packet 12 and the wire columns 34 formed on the sheet 24 correspond to any one of the exciting coils 54A to 54D.

The exciting coils 54A, 54B, 54C and 54D are provided with magnetic shields 66A, 66B, 66C and 66D respectively (generally referred to as magnetic shields 66), and the magnetic shields 66A to 66D respectively prevent magnetism from leaking into areas other than a predetermined area so as to limit the areas of the alternating magnetic fields formed by the exciting coils 54A to 54D.

That is to say, the magnetic shield 66A provided to the exciting coil 54A releases an area of a predetermined width on the right side of the transporting direction with respect to the center portion on the upper and the lower parts. The magnetic shield 66B provided to the exciting coil 54B releases an area of a predetermined width on the left side of the transporting direction with respect to the center portion on the upper and lower parts.

Further, the magnetic shield 66C provided to the exciting coil 54C releases an area of a predetermined width on the upper portion with respect to the center portion of the up-down direction on each of the side parts. The magnetic shield 66D provided to the exciting coil 54D releases an area of a predetermined width on the lower portion with respect to the center portion of the up-down direction on each of the side parts. As such magnetic shields, magnetism absorbers such as permalloy can be used.

As a result, in the packet 12, which is placed on the conveyor belt 46A and is moved, the magnetic wire columns 34 formed on the sheet 24 pass through a position opposed to any one of the released areas of the exciting coils 54A to 54D.

The exciting coils 54A to 54D are obtained easily by the exciting coils 54 having the same shape and by changing positions of their magnetic shields 66.

As shown in FIG. 7, in the reading apparatus 50, two detecting coils 56 are provided to each of the exciting coils 54A to 54D, and each of the detecting coils 56 is arranged so as to be opposed to the areas of the exciting coils 54 released from the magnetic shields 66.

That is to say, in the exciting coils 54A and 54B, one of the detecting coils 56 is provided to the released area above the packet 12, and the other one is provided to the released area below the packet 12. Further, in the exciting coils 54C and 554D, one of the detecting coils 56 is provided to the released area on the right side of the conveyor belt 46A, and the other one is provided to the released area on the left side of the conveyor belt 46A.

As a result, when the packet 12 is transported by the belt conveyor 46, the magnetic wires 30 of the sheet 24 stuck to the packet 12 face any one of the detecting coils 56 sequentially.

When the magnetic wires 30 which are not demagnetized face the detecting coils 56, the detecting coils 56 detect the response signals to the alternating magnetic fields applied to the magnetic wires 30 by the exciting coils 54.

The response signals detected by the exciting coils 54 are sequentially read by the controller 64. Further, when the two magnetic wires 30 forming the head pits 34A are opposed to the detecting coils 56, the response signals detected by the detecting coils 56 become strong. In another way, the two magnetic wires 30 are not formed, information for 1 bit which can be expressed by even one magnetic wire 30 is lost, but the head pit is not always demagnetized and may always expresses 1. Further, when the response signals from the magnetic wires 30 are not detected even at the timing where they are detected by the detecting coils 56, it can be determined that the magnetic wires 30 are demagnetized.

As a result, the controller 64 determines the head bits 34A from the detected response signals, and determines binary data (writing data) from the determined head bits 34A and presence/non-presence of the following response signals so as to analyze information written into the sheet 24 from the determined result.

At the sorting step 16, the packet delivered from the conveyor belt 46 is sorted based on the analyzed information.

In the delivery system 10 having such a configuration, the client who asks for the delivery of the packet 12 inputs necessary items into the sheet 24 using the PC 26 and the printer 28 so as to prepare a delivery ticket, and sticks the prepared delivery ticket (sheet 24) to a predetermined position of the packet 12.

At this time, in the printer 28, the information, which cannot be visually checked but is remotely readable, is written into the sheet 24.

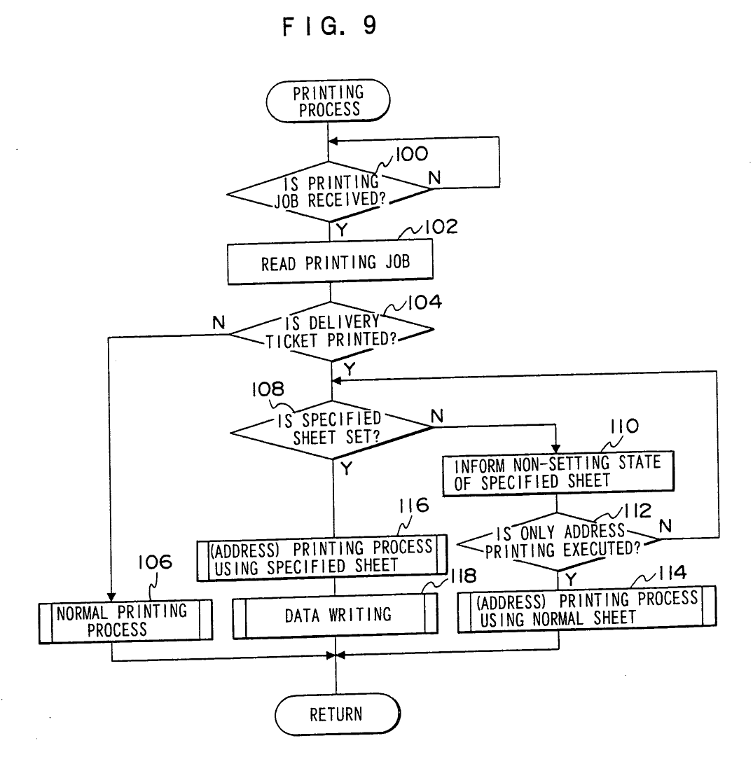

FIG. 9 illustrates a flow of the printing process executed by the printer 28. In this flowchart, at first step 100, when a printing job output from the PC 26 is received, a determination is made as YES so that the printing job is executed. When the PC 26 executes the printing process on the sheet 24 as the delivery ticket, it outputs the printing job as well as the data to be written into the sheet 24.

In the printer 28, when the printing job is output from the PC 26 and the determination is made as YES at step 100, the sequence goes to step 102, so that the printing job is read.

Thereafter, at step 104, a check is made as to whether or not the received printing job is generating the delivery ticket such that address or the like is printed on the sheet 24, and when the printing job is the normal printing process, a determination is made as NO at step 104, and the sequence goes to step 106 so that the normal printing process is executed.

On the contrary, when the received printing job is the printing process on a delivery ticket, the determination is made as YES at step 104, and the sequence goes to step 108 so that a check is made whether or not the sheet 24 is set. At this time, when the sheet 24 is not set, a determination is made as NO at step 108, and the sequence goes to step 110 so that the non-setting of the sheet 24 is informed. Further, at next step 112, a check is made whether only address printing is carried out or not.

At this time, when the carrying-out of only the address printing is specified, a determination is made as YES at step 112, and the sequence goes to step 114 so that the normal printing process (address printing) which uses recording paper set in the printer 28 is executed.

Further, when the printing process using the sheet 24 is executed, the determination is made as NO at step 112, and the sequence goes to step 108 so that the check is made again that the sheet 24 is set.

In this manner, when the setting of the sheet 24 is checked and the determination is made as YES at step 108, the sequence goes to step 116 so that the printing process on the sheet 24 is executed.

Thereafter, at step 118, the exciting coils 38 of the recording head 36 are operated based on the writing data transmitted as the printing job together with the data such as address, and the magnetic wires 30 are magnetized or demagnetized so that the data are written into the sheet 24 by using the wire columns 34.

As a result, the sheet 24, into which predetermined data as well as the address and the like are written, can be obtained. Here, this explanation refers to the outlines of the printing process and the data writing process on the sheet 24, and the flows of the printing process and the writing process are not limited to them.

The packet 12, to which the sheet 24 prepared in such a manner is attached, is delivered to a distributing company so as to be picked up at the sorting step 16. At this sorting step 16, the packet 12 is sorted based on the data written into the sheet 24.

At the sorting step 16, the packet 12 is transported to the turntable 48 by the belt conveyor 44. At this time, when the surface of the packet 12, to which the sheet 24 is attached, faces the transporting direction side (upper stream side or lower stream side of the transporting direction), the packet 12 is placed on the turntable 48 and the turntable 48 is rotated so that the direction of the packet 12 is changed.

The surface, to which the sheet 24 is attached, faces any one of the up-down direction and the left-right direction, and the packet 12 is sent from the turntable 48 to the belt conveyor 46.

The belt conveyor 46 is provided with the reading apparatus 50, and when the packet 12 is placed on the conveyor belt 46A of the belt conveyor 46 so as to be moved, the data written into the sheet 24 are read.

The reading apparatus 50 is provided with the exciting coils 54 (54A to 54D) formed into the rectangular loop shape, and the packet 12 passes through the exciting coils 54A to 54D sequentially in a predetermined direction.

The exciting coils 54A to 54D are respectively surrounded by the magnetic shields 66A to 66D except for predetermined set areas. As a result, in the exciting coils 54, the alternating magnetic fields are formed in the areas, which are not covered with the magnetic shields 66, and when the magnetic wires 30 are opposed to the areas, the detecting coils 56 can detect the response signals generated from the magnetic wires 30. The alternating magnetic field is not formed in the areas shielded by the magnetic shields 66, and even when the magnetic wires 30 are opposed to the areas, the alternating magnetic field is not applied to the magnetic wires 30. Further, even when the response signal is generated, this signal is not detected.

Further, in the controller 20 of the reading apparatus 50, the detected results in the detecting coils 56 are read and stored at a timing which is set based on the transporting speed of the packet 12 by means of the belt conveyor 46, the length L of the magnetic wires 30 and the interval D between the magnetic wires 30. The head pits 34A are determined from the stored detected results, and the information of the magnetic wires 30 is determined.

As a result, the data according to the binary code written into the sheet 24 can be obtained, and the writing data (writing information) are determined based on the former data.

At the sorting step 16, each packet 12 is sorted according to sections of the delivery destination based on the determined results in the reading apparatus 50.

In general, a readable amount of the magnetic wire rods 30 at the time of using the Barkhausen effect, namely, a readable amount of the data for one column formed by the magnetic wire rods 30 decreases when the moving speed of the packet 12 becomes fast. When the transporting speed is 1.5 m/sec, the readable amount of the data is 15 bits, when 2.0 m/sec, 10 bits, and when 4 m/sec, 5 bits. For example, in a sorting operation of postal matters, high sorting speed of 3.0 m/sec or more is required, but in this case, the expression of information is increased from 1 column to several columns, so that a reduction in an amount of information read by one column by means of high-speed reading can be compensated. Similarly in the case where the packet 12 is transported at 1.5 m/sec, therefore, the data written into the sheet 24 can be read at a higher moving speed, and while the packet 12 is being transported at a high speed, the packet 12 can be sorted.

At the sorting step 16, therefore, the speed of the sorting operation can be securely heightened, and thus the throughput can be improved.

Meanwhile, in this embodiment, the wire columns 34 are provided with the head pit 34A, and predetermined information is written as binary data after the head pit 34, but the information writing method is not limited to this.

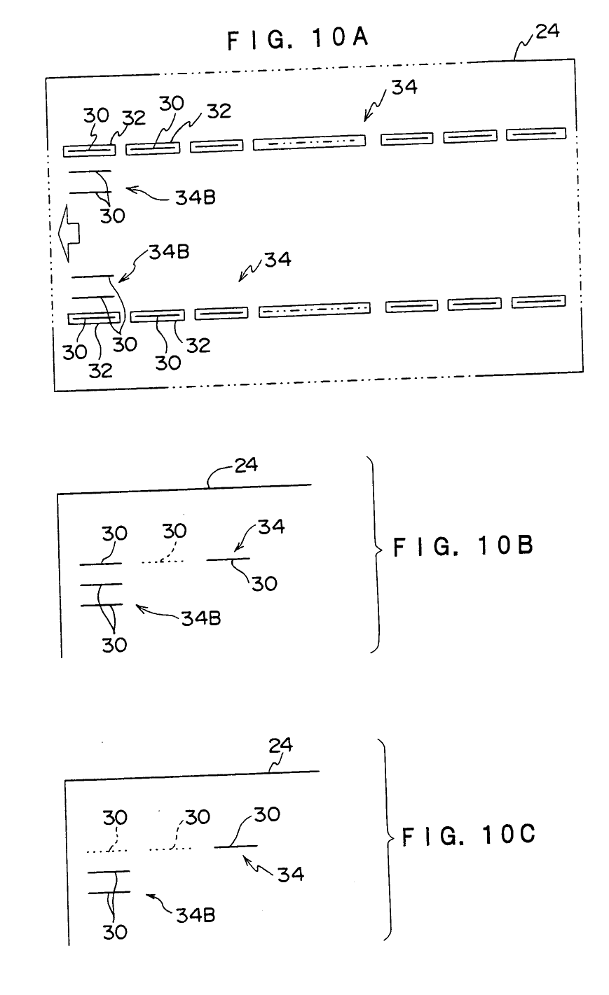

For example, as shown in FIG. 10A, the magnetic wire 30 on one end of the wire column 34 may be provided with a head pit 34B formed with two magnetic wires 30 (magnetic wires 30 which is not provided with the magnetic bands 32).

As a result, for example, when the first data are “1”, as shown in FIG. 10B, the magnetic wires 30 arranged on the head pit 34B are brought into the magnetized state, and when the first data are “0”, as shown in FIG. 10C, the magnetic wires 30 arranged on the head pit 34B are demagnetized.

As a result, information can be written by using all the magnetic wires 30 on the wire columns 34.

Further, the writing method is not limited to this, and when the intervals between the magnetic wires 30 are gradually increased or decreased, the head pit is not set and the direction of the data may be clarified.

Further, the magnitude of the response signals detected by the detecting coils 56 changes according to a length, a thickness, material physical properties, the number of wires presented, a space to be allocated for one piece of information and the like of the magnetic wires 30. For this reason, the writing information may be expressed by using them.

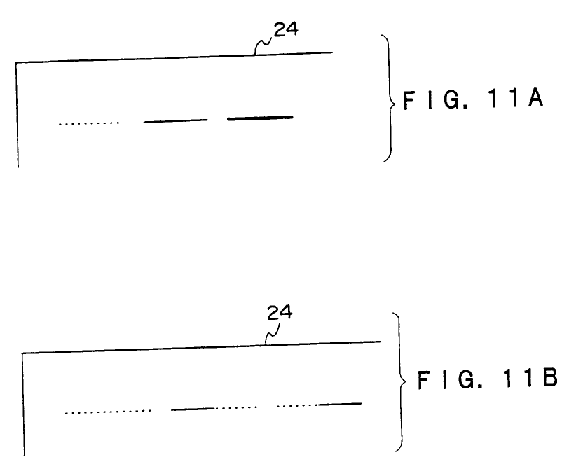

At this time, for example as shown in FIG. 11A, information may be written at three levels: the demagnetized state, a thin line; and a thick line. Further, as shown in FIG. 11B, information may be written at three levels: the demagnetized state (broken line), half-magnetized states (a demagnetized stat on the right side and a magnetized state on the left side of FIG. 11B). As a result, writing not in binary (binary data) but in ternary is enabled.

When data are written in multi-radix, more information can be written than in binary.

In this embodiment, a configuration in which the packet 12 moves straight without tilting in the exciting coils 54 has been explained, but a configuration in which the packet 12 moves in the exciting coils 54 in a tilted state is also possible.

Since the response signals of the magnetic wires 30 detected by the detecting coils 56 change according to the length of the packet along the moving direction, when the packet 12 tilts, the response signals become weak.

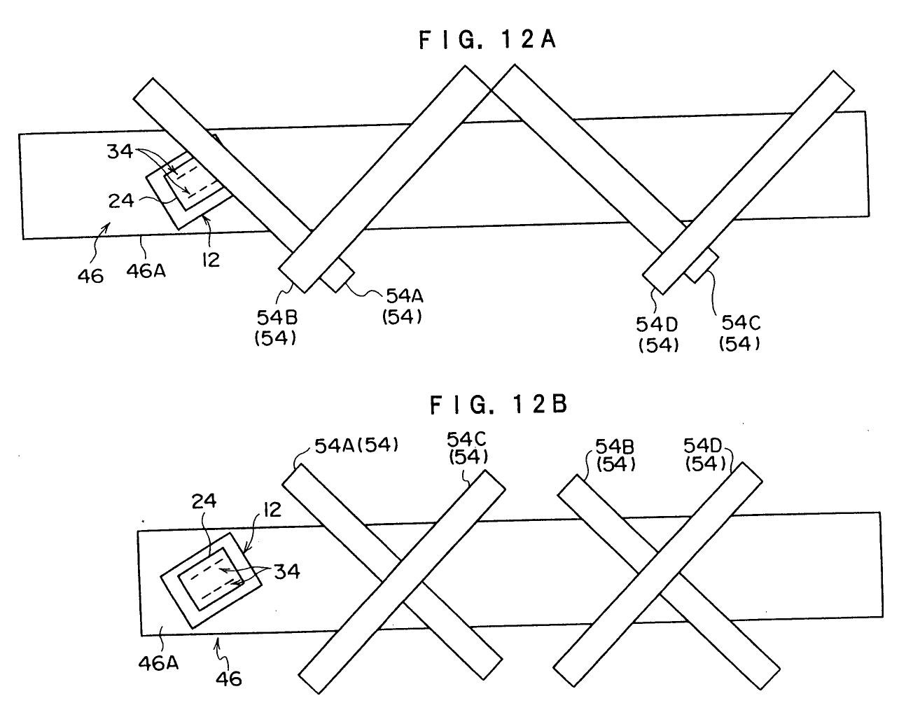

For this reason, as shown in FIG. 12A, the exciting coils 54A to 54D may be tilted at a predetermined angle (for example, 45° with respect to the moving direction of the packet 12) so as to be arranged.

At this time, as shown in FIG. 12B, the exciting coils 54A and 54B and the exciting coils 54C and 54D may be arranged so as to intersect with each other. As a result, space can be saved. When the gate is provided in such a manner, a troublesome operation for carefully arranging the packet 12 parallel to the advancing direction of the belt conveyor 46 so that its surface on the side of the sheet 24 faces the top-bottom sides properly will be unnecessary.

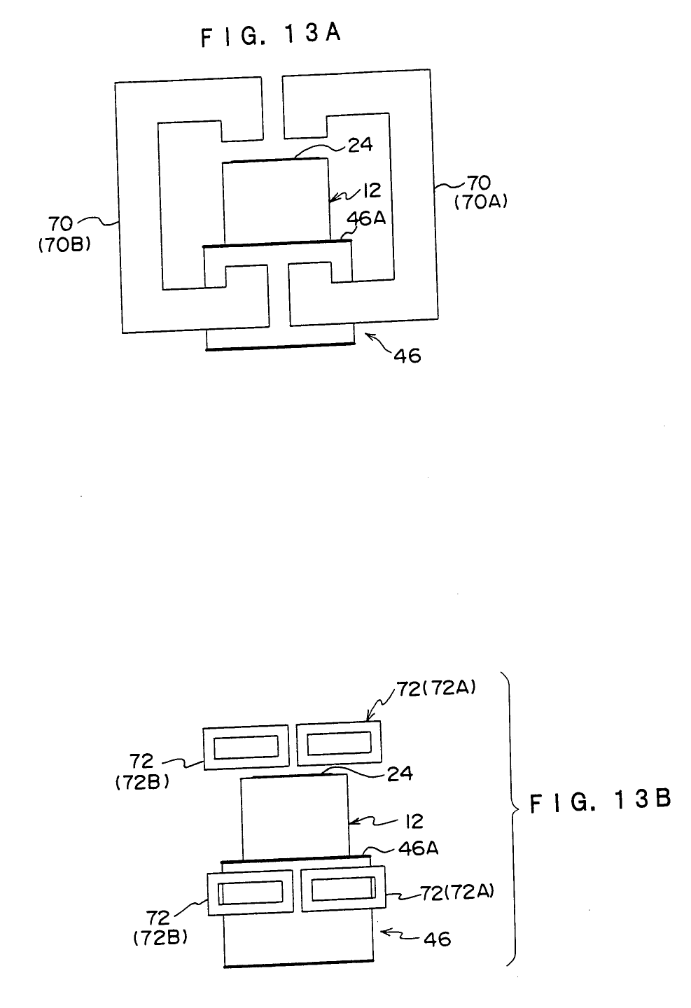

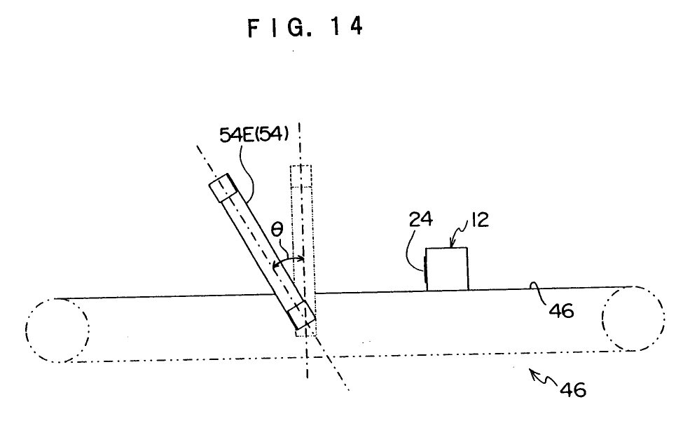

Further in this embodiment, the exciting coils 54 are formed into the rectangular loop shape, but for example as shown in FIG. 13A, the exciting coils 70 which are formed into a C-shaped are used and are arranged correspondingly to the sheets 24 on the respective surfaces of the packet 12.

Further, as shown in FIG. 13B, small exemplified coils 72 may be arranged correspondingly to the respective surfaces of the packet 12. FIG. 13A illustrates the exciting coils 70 (70A and 70B) corresponding to the exciting coils 54A and 54B, and FIG. 13B illustrates the exciting coils 72 (72A and 72B).

In this embodiment, the turntable 48 is provided, the surface of the sheet 24 faces the side along the transporting direction of the packet 12, but as shown in FIG. 14 for example, the exciting coil 54E which is tilted at a predetermined angle θ with respect to the vertical direction is provided, and thus when the sheet 24 is on the front side or the rear side of the packet 12, information can be read. The angle θ at this time can be within a range of 45° to 60°, and the tilting direction may be any one of the upper stream side and the lower stream side of the transporting direction of the packet. In order to read the sheet 24 stuck to the side surfaces or the upper and lower surfaces of the packet 12, however, it goes without saying that 45° is the most suitable.

The above-explained embodiment does not limit the configuration of the invention. For example, in this embodiment, the sheet 24 made of paper is used, but the sheet 24 is not limited to this, and arbitrary material such as a resin plate, a resin film, or metal foil can be applied to the sheet body.

Further, in this embodiment, information recorded in the sheet 24 is read at the sorting step 16 (20) when the packet 12 is delivered, and the process based on this information is executed. The invention can be, however, applied to an arbitrary configuration that reads information written into the sheet body according to the remote system while the sheet body is being transported.

At this time, not only the sheet body is transported, and the sheet body and the detecting section are relatively moved, and simultaneously the information written into the sheet body may be read.

This embodiment explains that the sorting process is executed based on the information read from the sheet body, but the invention is not limited to this and can be applied to an arbitrary process based on written information. Further, information to be written into the sheet body such as the sheet 24 can be applied to the writing of arbitrary information such as information for selectively executing a predetermined process.

What is claimed is:

1. A sheet body comprising a plurality of magnetic wires arranged and embedded along a longitudinal direction of the sheet body at a predetermined interval,
wherein each of the magnetic wires is formed by two kinds of magnetic bodies with different coercive forces into a linear shape of a predetermined length, and magnetized by a magnetic wire column with stronger coercive force, thereby preventing the magnetic wire column with weaker coercive force from generating a response signal to an alternating magnetic field.

2. A long sheet into which information is written comprising a plurality of magnetic wires embedded into the sheet and composed of magnetic wire rods and magnetic bands,
wherein the magnetic wires are arranged such that the magnetic wires compose a plurality of wire columns, and the wire columns include the magnetic wires arranged along a longitudinal direction of the sheet at a predetermined interval.

3. The sheet of claim 2, wherein the wire columns are arranged in parallel with each other.

4. The sheet of claim 2, wherein the magnetic wire rods and the magnetic bands have different coercive forces, and the magnetic wire column with stronger coercive force is magnetized so as to prevent the magnetic wire column with weaker coercive force from generating a response signal to an alternating magnetic field.

5. The sheet of claim 2, wherein the wire columns represent one bit of the information according to presence or non-presence of a response signal to an alternating magnetic field.

6. The sheet body of claim 2, wherein the longitudinal direction of the sheet is parallel with a transporting direction of the sheet.

7. The sheet body of claim 6, wherein a magnetic wire for enabling identification of a head bit is provided at a head, in the transporting direction, of at least one of the wire columns.

8. A long sheet into which information is written comprising a plurality of wire columns embedded into the sheet and arranged along a longitudinal direction of the sheet,
wherein the wire columns are composed of a plurality of magnetic wires arranged at a predetermined interval, and the magnetic wires are composed of magnetic wire rods and magnetic bands.

9. The sheet of claim 8, wherein the wire columns are arranged in parallel with each other.

10. The sheet of claim 8, wherein the magnetic wire rods and the magnetic bands have different coercive forces, and a magnetic wire column with stronger coercive force is magnetized so as to prevent a magnetic wire column with weaker coercive force from generating a response signal to an alternating magnetic field.

11. The sheet of claim 8, wherein the wire columns represent one bit of the information according to presence or non-presence of a response signal to an alternating magnetic field.

12. The sheet body of claim 8, wherein the longitudinal direction of the sheet is parallel with a transporting direction of the sheet.

13. The sheet body of claim 12, wherein a magnetic wire for enabling identification of a head bit is provided at a head, in the transporting direction, of at least one of the wire columns.

14. An information writing method of writing predetermined information into a sheet body into which wire columns where magnetic wires formed by two kinds of magnetic bodies with different coercive forces into a linear shape of a predetermined length are arranged at a predetermined interval are embedded, the writing method comprising:
relatively moving a magnetizing portion for magnetizing the magnetic wire column with stronger coercive force of the two magnetic bodies along a column direction of the wire columns, and simultaneously magnetizing the magnetic wire column with stronger coercive force selectively based on the information to be written.

15. The information writing method of claim 14, further comprising:
when the wire columns are provided to the sheet body, providing the magnetizing portions correspondingly to the wire columns so as to relatively move the magnetizing portions integrally with respect to the sheet body.

16. An information reading method of reading information from a sheet body, in which wire columns where magnetic wires formed by two kinds of different magnetic bodies with different coercive forces into a linear shape of a predetermined length are arranged at a predetermined interval are embedded, and into which the information is written by selectively magnetizing the magnetic wire column with stronger coercive force of the two magnetic bodies, the information reading method comprising:
applying an alternating magnetic field to the magnetic wires, relatively moving a detecting section which can detect a response signal generated from the magnetic wire column with weaker coercive force with respect to the alternating magnetic field along a column direction of the wire columns, and simultaneously reading presence and non-presence on the response signal according to positions of the magnetic wires.

17. An information reading apparatus that sorts an object to which a sheet body, into which wire columns where magnetic wires formed by two kinds of magnetic bodies with different coercive forces into a linear shape of a predetermined length are arranged at a predetermined interval are embedded and information is written by selectively magnetizing the magnetic wire column with stronger coercive force of the two magnetic bodies, is attached based on information written into the sheet body, the information reading apparatus comprising:
a transporting section that transports the object at a predetermined transporting speed;
an exciting coil that is provided so as to be opposed to the wire columns of the sheet body attached to the object to be transported by the transporting section and applies an alternating magnetic field;
a detecting section that detects a response signal when the magnetic wire column with weaker coercive force of the two magnetic bodies generates the response signal according to the alternating magnetic field applied by the exciting coil; and
a determining section that determines information written into the sheet body according to presence and non-presence of the response signals from the magnetic wires of the wire columns.

18. The information reading apparatus of claim 17, wherein the exciting coil is formed into a loop shape, and the object is transported through the loop by the transporting section.

19. The information reading apparatus of claim 18, wherein
the exciting coil includes:
a first exciting coil which is magnetically shielded so as to release magnetism to a predetermined area on upper and lower surfaces of the object; and
a second exciting coil which is magnetically shielded so as to release a predetermined area on side surfaces in a transporting direction of the object.

20. The information reading apparatus of claim 19, wherein when a plurality of wire columns are formed on the sheet body, the first and the second exciting coils and the detecting
section are provided for each of the wire columns.
